(19) United States
(12) Patent Application Publication
(10) Pub. No.: US 2010/0013845 A1
(43) Pub. Date: Jan. 21, 2010

(54) IMAGE DISPLAY APPARATUS AND PROGRAM FOR CONTROLLING IMAGE DISPLAY APPARATUS

(75) Inventor: Yasuhisa Yamamoto, Kitakyushu-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/503,765

(22) Filed: Jul. 15, 2009

(30) Foreign Application Priority Data
Jul. 16, 2008 (JP) 2008-184713

(51) Int. Cl. G09G 5/36

(52) U.S. Cl. 345/557

(57) ABSTRACT

An image display apparatus which includes an image memory for storing a synthetic image obtained by synthesizing a plurality of layer images and which displays the synthetic image stored in the image memory on a display unit.

This application claims priority to Japanese Patent Application No. 2008-184713, filed Jul. 16, 2009, the entirety of which is incorporated herein by reference.

### BACKGROUND

1. Technical Field

The present invention relates to a technology for displaying an image on an image display apparatus.

2. Related Art

In the past, photo viewers and stand-alone printers have been known. In the photo viewer, a specific image is searched for by sequentially displaying images on a liquid crystal display (LCD) on the basis of plural image files stored in a storage media such as a memory card, a USB memory, or an optical disc, and the specific image searched for is displayed on the liquid crystal display. In the stand-alone printer, the searched specific image is selected and printed on a print sheet. For example, an image display on the liquid crystal display is performed such that an encoded image is developed into an image in a raster format and transferred to an image memory (VRAM). Therefore, when a user operates an image transmission button continuously, the development of an image into the raster format and the transmission of the image developed into the raster format to the image memory are repeated taking a short amount of time for every operation of the image transmission button by the user.

When the user operates the image transmission button continuously, all of the images are developed into the raster format and the developed images are transmitted to the image memory according to the operation of the image transmission button by the user, regardless of the fact the image to be displayed on the display unit is switched to the next image in an instant. In this case, efficiency is very bad. Here, technology is proposed that, when the image transmission button is continuously operated by the user, at least the image selected by the final operation of the image transmission button by the user among the continuous operations of the image transmission button is displayed on the display unit (for example, JP-A-2007-241492, paragraphs 0022 to 0027, FIGS. 1 and 5, Abstract, etc.), instead of sequentially displaying the images according to all the operations of the image transmission button by the user. According to such a configuration, since at least the image corresponding to the final operation of the image transmission button caused by the user is displayed on the liquid crystal display, the display of the image selected by the final operations of the user is delayed, so that it is possible to achieve a reduction in the stress felt by the user. Moreover, among the images according to the operation of the image transmission button by the user, only the desired image is subjected to development into the raster format and only the image developed into the raster format is transmitted to the image memory, so that there is very little waste. Accordingly, efficiency is enhanced.

For example, when a photograph image taken by a digital still camera is displayed on a display unit such as the liquid crystal display, the photograph image is synthesized with a menu image and the photograph image and the menu image are simultaneously displayed on the display unit, and all of this is performed frequently. In recent years, overwriting is performed in real time on the photograph image under display on the display unit with an image drawn by a touch pen or the like. These operations are realized, for example, by developing plural layer images into the raster format to generate a synthetic image, and by displaying the synthetic image on the display unit, as hereinafter described.

That is, the synthetic image displayed on the display unit is generated by sequentially overlapping and synthesizing five layer images of a first layer image (background image of the photograph), a second layer image (photograph image), a third layer image (background image of characters), a fourth layer image (character and icon images), and a fifth layer image (image drawn by the touch pen) from a lower layer. At this time, the synthetic image in which characters, menus and a scribble image drawn by a touch pen are synthesized with each other on the photograph image is displayed on the display unit by performing a synthesizing process in the order, starting with the first layer image, described as follows:

(1) Developing the background image (the first layer image) of the photograph into the raster format in the image memory

(2) Overlapping the photograph image (the second layer image) with the first layer image stored in the image memory and developing the overlapped image into the raster format

(3) Overlapping the background image (the third layer image) of the characters with the first and second layer images stored in the image memory and developing the overlapped image into the raster format

(4) Overlapping the character and icon images (the fourth layer image) with the first to third layer images stored in the image memory and developing the overlapped image into the raster format

(5) Overlapping the image (the fifth layer image) drawn by the touch pen with the first to fourth layer images stored in the image memory and developing the overlapped image into the raster format

(6) Transmitting the synthetic image made of the first to fifth layer images stored in the image memory to the display unit.

In the above-mentioned synthesizing process of the layer images, when the photograph image displayed on the display unit is switched with the next photograph image, or when a part of the characters displayed on the display unit is changed, the developing processes into the raster format are always performed on all of the layer images. Thus, when a part of each layer image is changed, the developing processes into the raster format must be performed on all of the layer images. Therefore, the developing processes of the layer images into the raster format are particularly time consuming compared with other synthesizing processes. Accordingly, when a complicated synthetic image including a lot of layer images is generated, it takes a lot of time to generate the synthetic image and accordingly there is a danger of delay when the synthetic image is displayed on the display unit. In addition, when the scribble image or the characters are input on the synthetic image displayed on the display unit by using the touch pen, the scribble image and the characters are reflected on the synthetic image displayed on the display unit in real time. Therefore, despite the need to display to the user the changes that occur in the synthetic image, there is some delay in displaying the changed synthetic image, or, in some cases, the changed image is not reflected in the synthetic image displayed on the display unit. Accordingly, there is some fear that the user is very displeased.

In the above-mentioned existing technology, when the images are continuously displayed on the display unit, the developing processes of the images into the raster format are not performed during this continuous display, so that the images are not displayed continuously. Therefore, it is possible to rapidly display the image selected by the final operation of the image transmission button by the user. However, there is no mention of the fact the image displayed on the display unit is rapidly changed by the effective generation of the synthetic image displayed on the display unit. Accordingly, technology for effectively generating the synthetic image displayed on the display unit is desirable.

### SUMMARY

An advantage of some aspect of the invention is to provide a technology for effectively generating a synthetic image displayed on a display unit.

According to an aspect of the invention, there is provided an image display apparatus which includes an image memory for storing a synthetic image obtained by synthesizing a plurality of layer images and which displays the synthetic image stored in the image memory on a display unit, the apparatus including: a layer image input unit for inputting the layer images; a layer image storage unit for storing the layer images input by the layer image input unit; a development unit for developing the layer images stored in the layer image storage unit into developed layer images of a raster format; a cache image generating unit for forming a plurality of cache image generating groups by dividing the developed layer images into a plurality of groups, generating a cache image of the cache image generating group by synthesizing the developed layer images of the layer images provided that the cache image generating group includes a plurality of the layer images, and generating a cache image of the cache image generating group made of the developed layer image of one layer image provided that the cache image generating group includes the one layer image; an image cache unit for separately storing the cache image corresponding to every cache image generating group generated by the cache image generating unit; a synthesizing unit for synthesizing the cache images stored in the image cache unit into the synthetic image; a rewriting instruction unit for instructing the layer image storage unit to rewrite one layer image to a rewritten layer image according to inputting of the rewritten layer image for rewriting the one layer image among the layer images by the layer image input unit; and a layer image specifying unit, which operates according to a rewriting instruction issued by the rewriting instruction unit, for specifying the cache image including the developed layer image corresponding to the one layer image among the cache images as a specific cache image, and for specifying the layer images corresponding to all of the developed layer images constituting the specific cache image. Here, according to the rewriting instruction, the layer image storage unit stores the rewritten layer image instead of the one layer image, the development unit develops the layer image specified by the layer image specifying unit, the rewritten layer image among the rewritten layer images stored in the layer image storage unit and the layer images except the one layer image, and the cache image generating unit newly generates the cache image on the basis of the developed layer images developed according to the rewriting instruction and all of the cache images except the specified cache image among the cache images stored in the image cache unit.

According to another aspect of the invention, there is provided a program for an image display apparatus which includes an image memory for storing a synthetic image obtained by synthesizing a plurality of layer images and which displays the synthetic image stored in the image memory on a display unit, the program causing the image display apparatus to comprise: a function of inputting the layer images by using a layer image input unit; a function of storing the layer images input by the layer image input unit in a layer image storage unit; a developing function of developing the layer images stored in the layer image storage unit into developed layer images of a raster format; a cache image generating function of forming a plurality of cache image generating groups by dividing the developed layer images into a plurality of groups, generating a cache image of the cache image generating group by synthesizing the developed layer images of the layer images provided that the cache image generating group includes a plurality of the layer images, and generating a cache image of the cache image generating group made of the developed layer image of one layer image provided that the cache image generating group includes the one layer image; a function of separately storing the cache image corresponding to every cache image generating group generated by the cache image generating unit in an image cache unit; a synthesizing function of synthesizing the cache image stored in the image cache unit into the synthetic image; a rewriting instruction function of instructing the layer image storage unit to rewrite one layer image to the rewritten layer image according to inputting of the rewritten layer image for rewriting the one layer image among the layer images by the layer image input unit; and a layer image specifying function, which operates according to a rewriting instruction issued by the rewriting instruction unit, of specifying the cache image including the developed layer image corresponding to the one layer image among the cache images as a specific cache image, and of specifying the layer images corresponding to all of the developed layer images constituting the specific cache image. Here, according to the rewriting instruction, the rewritten layer image is stored in the layer image storage unit instead of the one layer image, the development function causes the layer image specified by the layer image specifying function and the rewritten layer image to be developed among the rewritten layer images stored in the layer image storage unit and the layer images except the one layer image, and the cache image generating function causes the cache image to be newly generated on the basis of the developed layer images developed according to the rewriting instruction and all of the cache images except the specified cache image among the cache images stored in the image cache unit.

In such a configuration of the invention, when the rewritten layer image for rewriting one layer image among the layer images is input to the layer image input unit, the layer image storage unit stores the rewritten layer image instead of the one layer image according to the rewriting instruction of the rewriting instruction unit. The development unit develops the layer image specified by the layer image specifying unit, the rewritten layer image among the rewritten layer images stored in the layer image storage unit and the layer images except the one layer image according to the rewriting instruction. In addition, the cache image generating unit newly generates the cache image on the basis of a developed layer image developed according to the rewriting instruction and all of the cache images except the specific cache image among the cache images stored in the image cache unit. Therefore, instead of developing all of the layer images including the rewritten layer image stored in the layer image storage unit into the raster format, some layer images among the layer images stored in the layer image storage unit and the rewritten layer image for the rewriting are developed into the raster format, and thereby enabling the cache image to be newly generated. Further, the newly generated cache image is synthesized by the synthesizing unit, and thereby enabling the synthetic image to be effectively generated.

In the past, all of the layer images stored in the layer image storage unit were developed into the raster format to generate the cache images, and the synthetic image was generated by synthesizing the generated cache images. On the contrary, with such a configuration of the invention, the layer images are developed into the raster format to obtain the developed layer images which are arbitrarily combined and synthesized with each other to form the cache images. Then, the cache images are stored in the image cache unit. When one layer image is rewritten, it is possible to generate the cache image required to generate the synthetic image simply by developing a desired layer image among the layer images stored in the layer image storage unit into the raster format by the use of the cache images stored in the image cache unit. Therefore, the number of processes required for developing the layer images into the raster format can be reduced. Accordingly, the time taken to newly generate the synthetic image when the one layer image is rewritten can be shortened. In addition, the time necessary to display the synthetic image obtained by rewriting the one layer image with the rewritten layer image on the display unit can be reduced.

In the image display apparatus, the image cache unit stores at least three cache images. According to the rewriting instruction, the cache image generating unit generates at least one cache image made of one of the developed layer images corresponding to the layer images except the rewritten layer image, and one cache image made of only the developed layer image corresponding to the rewritten layer image.

It is highly probable that the one layer image subjected to the rewriting with the rewritten layer image will be rewritten with a new rewritten layer image again. According to the above-mentioned configuration, since the cache image generating unit generates the one cache image made of only the developed layer image corresponding to the rewritten layer image according to the rewriting instruction issued by the rewriting instruction unit, when the rewritten layer image is rewritten again, it is possible to rewrite the synthetic image displayed on the display unit simply by developing the newly input rewritten layer image into the raster format. Therefore, efficiency is very good. For this reason, it is possible to display the image drawn by the touch pen on the display unit in real time even though the one layer image is subjected to continuous rewriting as in the case of the images drawn by the touch pen.

In the image display apparatus, the image cache unit includes the first to third caches to store the three cache images. The layer image input unit inputs “N” layer images from a lower first layer image to an upper Nth layer image. The cache image generating unit divides the developed “N” layer images obtained by developing the first to Nth layer images into three groups of first to third cache image generating groups from a lower layer in this order, and generates the first to third cache images corresponding to the first to third cache image generating groups, respectively. The image cache unit stores the first to third cache images in the first to third caches from a lower layer. In addition, according to the rewriting instruction, when the rewritten layer image is an image to rewrite the uppermost Nth layer image, the cache image generating unit newly generates first and second cache images on the basis of the first cache image, the second cache image, and all of the developed layer images corresponding to the layer images lower than the Nth layer image among the developed layer images constituting the third cache image, and newly generates the third cache image on the sole basis of the developed layer image obtained by developing the rewritten layer image.

According to such a configuration, the image cache unit is provided with “3” caches of the first to third caches to store three cache images. When the rewritten layer image is an image to rewrite the uppermost Nth layer image, according to the rewriting instruction, the cache image generating unit newly generates the third cache image only from the developed layer image obtained by developing the rewritten layer image. Thus, the cache image made of the developed layer image obtained by developing the rewritten layer image for rewriting the uppermost layer image can be stored alone in the third cache in a state independent from the developed layer images corresponding to the other layer images. Therefore, when the rewritten layer image is rewritten with a new rewritten layer image again, it is possible to rewrite the cache image stored in the third cache by using the third cache image newly generated by developing only the newly input rewritten layer image into the raster format. Therefore, efficiency is very good.

In the image display apparatus, according to the rewriting instruction, when the rewritten layer image is an image to rewrite the lowermost first layer image, the cache image generating unit newly generates third and second cache images on the basis of the third cache image, the second cache image, and all of the developed layer images corresponding to the layer images higher than the first layer image among the developed layer images constituting the first cache image, and newly generates the first cache image on the sole basis of the developed layer image obtained by developing the rewritten layer image.

According to such a configuration, when the rewritten layer image is an image to rewrite the lowermost first layer image, according to the rewriting instruction, the cache image generating unit newly generates the first cache image only from the developed layer image obtained by developing the rewritten layer image. Thus, the cache image made of the developed layer image obtained by developing the rewritten layer image for rewriting the lowermost layer image can be stored alone in the first cache in a state independent from the developed layer images corresponding to the other layer images. Therefore, when the rewritten layer image is rewritten again with a new rewritten layer image, it is possible to rewrite the cache image stored in the first cache by using the first cache image newly generated by developing only the newly input rewritten layer image into the raster format. Therefore, efficiency is very good.

In the image display apparatus, according to the rewriting instruction, when the rewritten layer image is an image to rewrite the nth (n: 2≦n≦N−1) layer image, the cache image generating unit newly generates a first cache image on the basis of the developed layer image corresponding to the layer images lower than the nth layer image, newly generates a third cache image on the basis of the developed layer image corresponding to the layer images higher than the nth layer image, and newly generates the second cache image on the sole basis of the layer image obtained by developing the rewritten layer image.

According to such a configuration, when the rewritten layer image is an image to rewrite the intermediate nth layer image, according to the rewriting instruction, the cache image generating unit newly generates the second cache image only from the developed layer image obtained by developing the rewritten layer image. Thus, the cache image made of the developed layer image obtained by developing the rewritten layer image for rewriting the intermediate layer image can be stored alone in the second cache in a state independent from the developed layer images corresponding to the other layer images. Therefore, when the rewritten layer image is rewritten again with a new rewritten layer image, it is possible to rewrite the cache image stored in the second cache by using the second cache image newly generated by developing only the newly input rewritten layer image into the raster format. Therefore, efficiency is very good.

### BRIEF DESCRIPTION OF THE DRAWINGS

The invention will be described with reference to the accompanying drawings, wherein like numbers reference like elements.

FIG. 1 is a perspective view illustrating a photo printer of an image display apparatus according to an embodiment of the invention.

FIG. 2 is a view schematically illustrating an internal configuration of a photo printer.

FIG. 3 is a block diagram illustrating a configuration of a controller.

FIG. 4A is a view illustrating a state of cache images independently stored in a cache memory.

FIG. 4B is a view illustrating a state of cache images independently stored in a cache memory.

FIG. 4C is a view illustrating a state of cache images independently stored in a cache memory.

FIG. 4D is a view illustrating a state of cache images independently stored in a cache memory.

FIG. 5 is a view illustrating an example of a cache process of a layer image.

FIG. 6 is a view illustrating an example of a lower layer process.

FIG. 7 is a view illustrating an example of an upper layer process.

FIG. 8 is a view illustrating an example of a development process.

FIG. 9 is a view illustrating an example of a process when a layer image is newly input.

FIG. 10 is a view illustrating an example of a process when a part of a layer image is rewritten.

FIG. 11 is a view illustrating an example of a process when a part of a layer image is rewritten.

FIG. 12 is a view illustrating an example of a process when a part of a layer image is rewritten.

FIG. 13 is a view illustrating an example of a process when a part of a layer image is rewritten.

### DESCRIPTION OF EXEMPLARY EMBODIMENTS

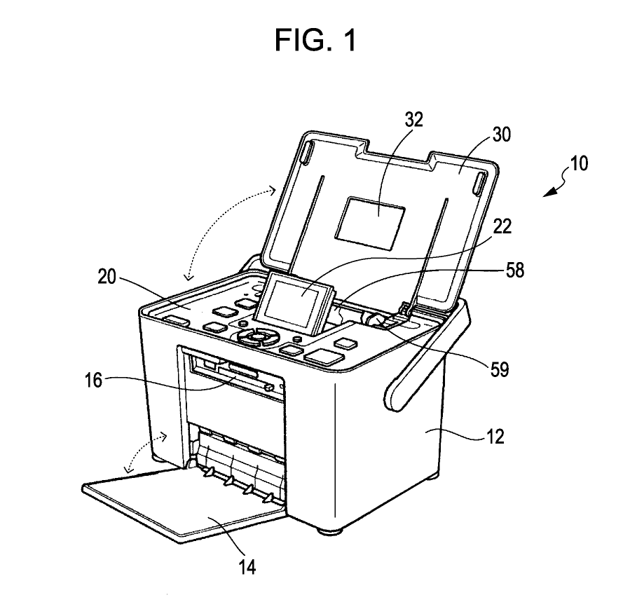

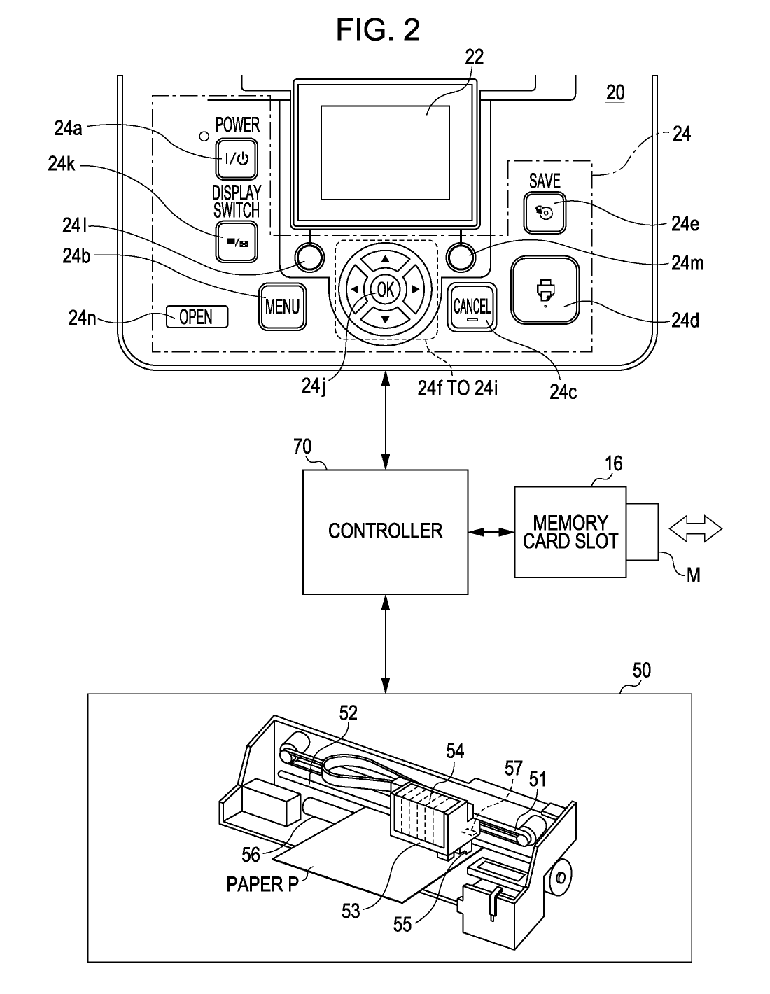

FIG. 1 is a perspective view illustrating a photo printer 10 of an image display apparatus according to an embodiment of the invention. FIG. 2 is a view schematically illustrating an internal configuration of the photo printer 10. A print mechanism 50 (see FIG. 2) is built in a printer body 12 of the photo printer 10. The photo printer 10 performs printing on a paper P according to an operational command issued from a controller 70 (see FIG. 2) which is responsible for controlling the entire photo printer 10. Then, the paper printed in this way is discharged to the front surface of the printer body 12.

As shown in FIG. 1, in the front surface of the printer body 12, a front surface door 14 is attached to be freely opened and closed. The front surface door 14 is a cover for opening and closing the front surface of the printer body 12. In an open state, the front surface door 14 serves as a sheet discharge tray for receiving the paper P discharged from the print mechanism 50. In addition, various memory card slots 16 which are provided on the front surface of the printer body 12 are in an available state for the user. That is, in this state, the user can insert a memory card M stored with image files as a print target into the memory card slot 16. For example, there may be provided with an optical disc drive (ODD) at the base portion of the printer body 12, so that a disc such as a compact disc (CD) for music or a digital versatile disc (DVD) for video may be used as a recording medium. Plural image files taken by an imaging device such as a digital still camera are stored in the memory card M and the disc.

In addition, an operation panel 20 is provided on the upper surface of the printer body 12. On the other hand, a cover 30 is attached to be freely opened and closed on the rear side of the upper surface of the printer body 12. The cover 30 is a molded resin plate sized to cover the upper surface of the printer body 12. In the open state, the surface of the operation panel 20 is exposed to the outside (see FIG. 1). On the other hand, when the cover 30 is in the closed state, the operation panel 20 is entirely covered.

The operation panel 20 is provided with a display unit 22 for displaying characters, drawings, symbols, and the like, and a button group 24 which is disposed in the vicinity of the display unit 22. As shown in FIG. 2, the button group 24 is configured to include a power button 24a for turning on and off the power, a menu button 24b for calling a main menu screen, a cancel button 24c for canceling the operation while it is underway or for stopping the printing operation on the paper P while it is underway, a print button 24d for instructing a print action on the paper P, a save button 24e for storing an edited image or the like to the memory card M inserted into the memory case slot 16, arrow buttons 24f to 24i of the left, right, top, and bottom directions which are operated when the user selects a desired option from plural options displayed on the display unit 22 or when the user moves a cursor on the display unit 22, an OK button 24j which is disposed in the center portion of the arrow buttons 24f to 24i of the left, right, top, and bottom directions and is used to confirm the option selected by the respective arrow buttons 24f to 24i, a display switch button 24k for switching the screens to be displayed on the display unit 22, a left guide selection button 24l for selecting a left guide displayed on the display unit 22, a right guide selection button 24m for selecting a right guide displayed on the display unit 22, and a discharge sheet tray open button 24n for opening the front surface door 14 serving as the discharge sheet tray.

In addition, in order to confirm the display content displayed on the display unit 22, a window 32 with the same size as that of the display unit 22 is provided in the cover 30. That is, when the cover 30 is in the closed state, the user can confirm the display content displayed on the display unit 22 through the window 32. On the other hand, as shown in FIG. 1, when the cover 30 is in the open state, the display unit 22 can be adjusted to a desired angle.

In this way, when the cover 30 is in the open state, the cover 30 is held in a state inclined obliquely backward with respect to the operation panel 20 and thereby serves as the tray for feeding the paper P to the print mechanism 50. Further, at the rear of the operation panel 20, a paper feed port 58 of the print mechanism 50 is provided, and a pair of sliding paper guides 59 are provided which allow adjustment in the horizontal direction to fit the guide width to the paper width.

The paper P is transferred to the print mechanism 50 through the paper feed port 58 and the printing is executed. As shown in FIG. 2, in the print mechanism 50, a carriage 53 is driven by a timing belt 51 stretched in a loop shape in the horizontal direction, and moves reciprocally along the guide 52 in the horizontal direction. A paper edge detection sensor 57 is provided at the carriage 53 in order to detect the right and left edges and the upper and lower edges of the paper P. That is, the paper edge detection sensor 57 detects the right and left edges of the paper set on the paper feed port 58 when the carriage 53 is scanned in the horizontal direction before printing, so that the width of the paper can be recognized. Further, the paper edge detection sensor 57 detects the rear edge of the paper during printing, so that the length of the paper can be recognized.

In addition, ink cartridges 54 are mounted on the carriage 53, and each of which separately accommodates each color of ink such as cyan, magenta, yellow, and black. These ink cartridges 54 are connected to print heads 55, respectively. The ink cartridges 54 apply pressure on the ink therein, and the print heads 55 eject the ink onto the paper P through nozzles (not shown). In this embodiment, a method of pressing the ink by applying a voltage on a piezoelectric element is employed for the print heads 55. However, a method may be employed in which a voltage is applied on a heating resistor (for example, a heater etc.) to heat the ink and the ink is thereby pressed by generated bubbles. The paper P printed in this way is transferred to the front surface door (sheet discharge tray) 14 by a transport roller 56.

In addition, a battery pack can be mounted on the rear surface of the printer body 12, so that it is possible to operate the photo printer 10 by using the battery even when commercial power is not connected thereto. Owing to this and to the fact that the photo printer 10 is a stand-alone printer capable of being used without connection to a host computer, the photo printer 10 can be easily carried and used anywhere.

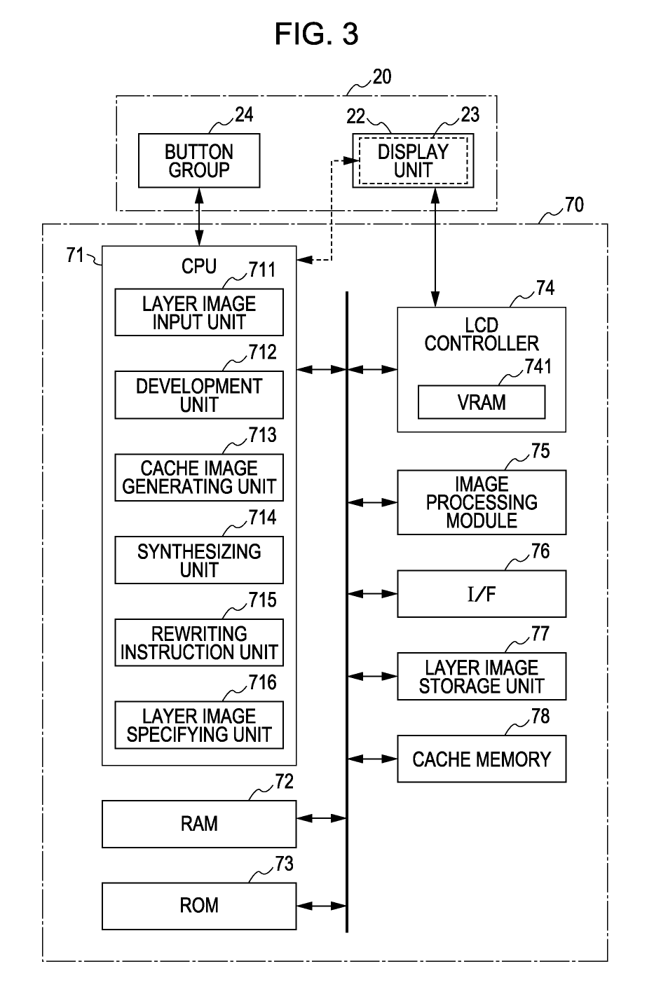

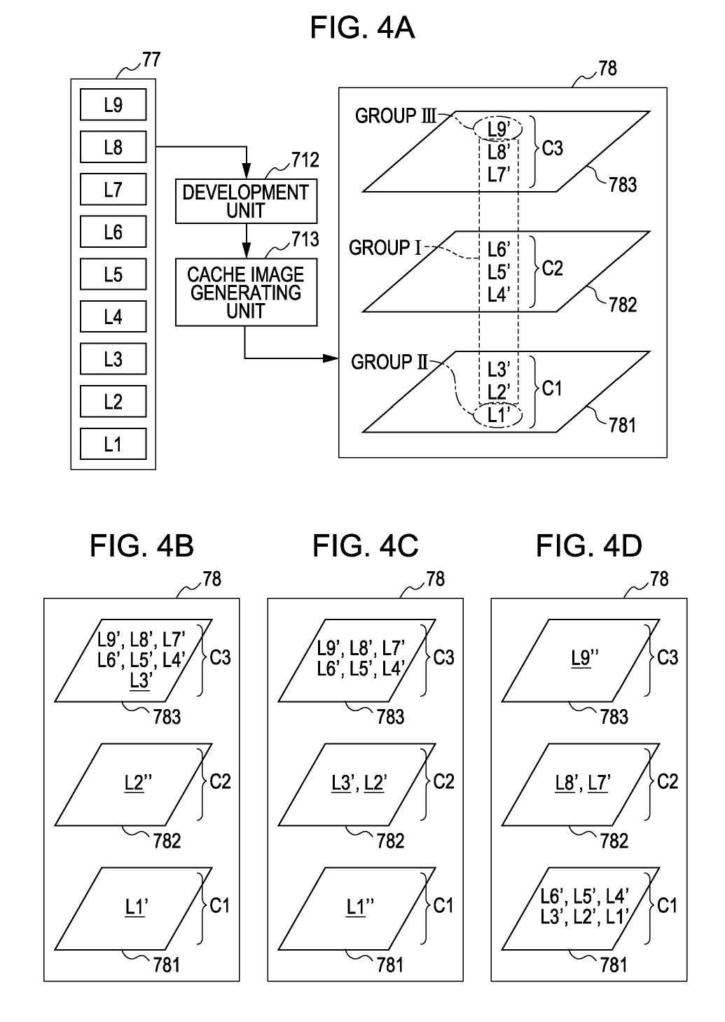

FIG. 3 is a block diagram illustrating a configuration of the controller 70. FIG. 4 is a view illustrating a state of plural cache images C1 to C3 independently stored in a cache memory 78. As shown in FIG. 3, the controller 70 is configured as a micro processor which is focused on a CPU 71 and is provided with a RAM 72 for storing a variety of data temporarily, a ROM 73 for storing various processing programs and a variety of data as well as various programs and various tables, an interface (I/F) 76 for communication with the print mechanism 50, the memory card slot 16, a USB memory (not shown), and the like. In addition, the controller 70 is provided with a layer image storage unit 77 for storing the layer images L1 to L9 which are input by a layer image input unit 711 to be described later, and a cache memory 78 (which corresponds to an “image cache unit” in the invention) for storing the cache images C1 to C3 which are generated by a cache image generating unit 713 by arbitrarily combining the developed layer images L1′ to L9′ developed into the raster format by the development unit 712 to be described later (see FIG. 4). As shown in FIG. 4, the cache memory 78 is provided with first to third caches 781 to 783 to separately store the three images of the first to third cache images C1 to C3. Further, the cache memory 78 is configured to store the cache images C1 to C3 in the first to third caches 781 to 783 in order from the first cache image C1 in the lower layer. In addition, the controller 70 outputs control signals to the print heads 55 of the print mechanism 50, and outputs control signals to the display unit 22 of the operation panel 20 in addition to storing the edited images in the memory card M or the USB memory.

In addition, in the controller 70, an image processing module 75 is provided in order to perform necessary image processing on image data given by an external memory medium such as the memory card M through the I/F 76. The image processing module 75 has a function of generating image data corresponding to a unique printer image such as a menu screen to be displayed on the display unit 22.

RGB image data output from the image processing module 75 is given to an LCD controller 74 for controlling the display of the display unit 22. The LCD controller 74 is provided with a VRAM 741 (which corresponds to the “image memory” in the invention). The respective cache images C1 to C3 stored in the cache memory 78 are synthesized by the synthesizing unit 714 to be described later, and the synthetic image is stored in the VRAM 741. The synthetic image stored in the VRAM 741 is transmitted from the LCD controller 74 to the display unit 22 at a predetermined timing, so that the synthetic image is displayed on the display unit 22.

In the following, the number of pixels of the display unit 22 configured by an LCD display corresponds to the “320×240” dots of the quarter video graphics array (QVGA) format. In this configuration, one line of the image is configured of “320” dots of the image data, and one image is configured of “240” lines of the line data. In addition, in the example shown in FIG. 4, three images of the first to third cache images C1 to C3 are generated on the basis of nine layer images L1 to L9, and the generated first to third cache images C1 to C3 are stored in three caches of the first to third caches 781 to 783. However, the number of the layer images to be input by the layer image input unit 711, the number of the cache images to be generated, and the number of the cache images to be stored in the cache memory 78 are not limited to these numbers described above, but any number may be used.

In addition, as shown in FIG. 3, a touch panel 23 is provided on the display unit 22, so that the user can directly input the scribble image on any position of the synthetic image displayed on the display unit 22 by the use of the touch panel 23. The touch panel 23 is made of a transparent material or a translucent material, and is integrally formed with the display unit 22. Alternatively, in a state where the touch panel 23 is provided by bonding to the display screen of the display unit 22, it is constructed so that the image displayed on the display unit 22 can be recognized by the user. In addition, while looking at the image such as the synthetic image displayed on the display unit 22, the user touches the touch panel 23 using the equipped pen, so that a signal corresponding to the coordinates on the touch panel 23 touched by the pen is output to the CPU 71 (the layer image input unit 711). Therefore, in the state where the synthetic image is displayed on the display unit 22, when the user tries to scribble on any position of the synthetic image displayed on the display unit 22, the user can input the position on the synthetic image that they desire to scribble on to the CPU 71 by touching any position of the touch panel 23 which is provided on the display unit 22 and overlapped with the display screen thereof with the substantially same size.

When the user moves the pen on the touch panel 23 while looking at the image displayed on the display unit 22, the signals representing the coordinates of the pen moving on the touch panel 23 are output to the CPU 71 continuously. The image processing module 75 generates the scribble image on the basis of the coordinate signals. Therefore, by moving the pen on the touch panel 23 while looking at the synthetic image displayed on the display unit 22, the user can draw any scribble image. The layer image input unit 711 receives the generated scribble image (layer image) as an input, and the input scribble image is stored in the layer image storage unit 77, which will be described later.

In addition, as the configuration of the touch panel 23, various types such as an optical type, a capacitive type, a type using a transparent electrode and a film substrate, a resistive film, a surface acoustic wave type, and the like can be employed. Since the configurations of the various types described above are known already, the explanations and operations thereof will be omitted. Even if a so-called pen type input device is employed instead of the touch panel 23, the same effect can be obtained from the invention. In addition, instead of the touch panel 23, it is matter of course that the same effect can be obtained as long as the user can visually and directly instruct the position of the synthetic image displayed on the display unit 22, no matter what input device is employed.

In addition, in this embodiment, various programs for controlling the screen display are stored in the ROM 73, and the functions thereof are realized when these programs are performed by the CPU 71. Next, the functions which are realized by causing the CPU 71 to perform the programs for controlling the display of the screen stored in the ROM 73 will be described with reference to FIGS. 3 and 4.

As shown in FIG. 3, by causing the CPU 71 to perform the programs stored in the ROM 73, the CPU 71 is configured to realize the functions as follows: A function as the layer image input unit 711 for inputting the layer images L1 to L9 shown in FIG. 4, a function of storing the layer images L1 to L9 input by the layer image input unit 711 in the layer image storage unit 77, and a function as the development unit 712 for developing the layer images L1 to L9 stored in the layer image storage unit 77 into the developed layer images L1′ to L9′ of the raster format are realized. In addition, as shown in FIG. 4, the CPU 71 is configured to realize a function as follow: The CPU 71 classifies the developed layer images L1′ to L9′ into plural cache image generating groups. When the cache image generating group is configured of plural layer images, these layer images are synthesized with each other to generate the cache images (refer to C1 to C3 shown in FIG. 4A, C3 shown in FIG. 4B, C2 and C3 shown in FIG. 4C, and C1 and C2 shown in FIG. 4D) of the corresponding cache image generating group. When the cache image generating group is configured of one layer image, the CPU 71 serves as the cache image generating unit 713 which generates the cache image (refer to C1 and C2 shown in FIG. 4B, C1 shown in FIG. 4B, and C3 shown in FIG. 4C) of the corresponding cache image generating group made of the one layer image.

In addition, as shown in FIG. 4, the CPU 71 is configured to realize a function of separately storing the cache images C1 to C3 of every cache image generating group generated by the cache image generating unit 713 in the first to third caches 781 to 783 of the cache memory 78, respectively. Then, the cache images C1 to C3 stored in the cache memory 78 are synthesized to generate the synthetic image by the function of the synthesizing unit 714 provided at the CPU 71.

In addition, when the layer image input unit 711 receives the rewritten layer image from the touch panel 23, in order to rewrite one layer image among the layer images L1 to L9, the CPU 71 is configured to realize a function as a rewriting instruction unit 715 for instructing the layer image storage unit 77 to rewrite one layer image to the rewritten layer image. Further, according to the rewriting instruction issued by the rewriting instruction unit 715, the CPU 71 is configured to realize a function as a layer image specifying unit 716 for specifying the cache image including the developed layer image corresponding to one layer image as a specific cache image among the cache images C1 to C3 and for specifying the layer image corresponding to all of the developed layer images constituting the specific cache image.

According to the rewriting instruction issued by the rewriting instruction unit 715, the layer image storage unit 77 stores the rewritten layer image instead of one layer image, and the development unit 712 develops the layer image specified by the layer image specifying unit 716 and the rewritten layer image among the rewritten layer images stored in the layer image storage unit 77 and the layer images except the one layer image. Then, the cache image generating unit 713 newly generates the cache images C1 to C3 on the basis of the developed layer image developed according to the rewriting instruction and all of the cache images except the specific cache image among the cache images C1 to C3 stored in the cache memory 78. Finally, the newly generated synthetic image is stored in the VRAM 741, and thus the synthetic image obtained by rewriting one layer image with the rewritten layer image is displayed on the display unit 22.

Next, the rewriting of one layer image with the rewritten layer image will be described using a specific example with reference to FIG. 4. In the example shown in FIG. 4, the layer image input unit 711 is configured to input “9” layer images L1 to L9 from the lower first layer image L1 to the upper ninth layer image. In addition, the cache image generating unit 713 is configured to classify the “9” developed layer images L1′ to L9′ obtained by developing the first to ninth layer images L1 to L9 into “3” groups of first to third cache image generating groups in the order from the lower layer. However, as shown in FIG. 4A, when the layer images L1 to L9 are newly input, the developed layer images L1′ to L3′ are classified into the first cache image generating group, the developed layer images L4′ to L6′ are classified into the second cache image generating group, and the developed layer images L7′ to L9′ are classified into the third cache generating group. The cache image generating unit 713 generates the first to third cache images C1 to C3 corresponding to the first to third cache image generating groups, respectively. Then, the generated first to third cache images C1 to C3 are stored in the first to third caches 781 to 783 in order from the lower layer.

(1) Rewriting of Layer Images L2 to L8 in GROUP I with Rewritten Layer Image

As shown in FIG. 4B, for example, when the rewriting instruction unit 715 issues the rewriting instruction to rewrite the second layer image L2 with the rewritten layer image L2″, the layer image specifying unit 716 specifies the first cache image C1 including the developed layer image L2′ as the specific cache image, and specifies the developed layer images L1′ and L3′ as constituting the specific cache image. Then, the development unit 712 develops the rewritten layer image L2″ and the layer images L1 and L3 corresponding to the developed layer images L1′ and L3′ specified by the layer image specifying unit 716. Next, the cache image generating unit 713 newly generates the first cache image C1 on the basis of the developed layer image L1′ corresponding to the first layer image L1 lower than the second layer image L2, and generates the third cache image C3 on the basis of the developed layer image L3′ corresponding to the third to ninth layer images L3 to L9 higher than the second layer image L2 and the second and third cache images C2 and C3.

Finally, the cache image generating unit 713 newly generates the second cache image C2 solely from the developed layer image obtained by developing the rewritten layer image L2″, and the generation process of the cache images C1 to C3 is ended. Further, the underlines shown in FIG. 4B show the newly developed layer images at the time of rewriting the second layer image L2. In general, when the layer images L1 to L9 are newly input, all of the layer images L1 to L9 must be developed. However, simply by developing “3” images of the layer images L1, L2″, and L3 into the raster format using the second and third cache images C2 and C3, it is possible to perform the rewriting of the second layer image L2 with the rewritten layer image L2″ and thereby increase efficiency.

In addition, it is possible to store the cache image C2, which is made of the developed layer image obtained by developing the rewritten layer image L2″ used for rewriting the second layer images L2, in the second cache 782 in a state independent from the developed layer images L1′, L3′ to L9′ corresponding to the other layer images L1, L3 to L9. Therefore, when the rewritten layer image L2″ is rewritten with a new rewritten layer image again, it is possible to perform the rewriting of the cache image stored in the second cache 782 by the use of the second cache image C2 newly generated by developing only the newly input rewritten layer image into the raster format, thereby greatly increasing efficiency.

(2) Rewriting of Layer Image L1 in GROUP II with Rewritten Layer Image

As shown in FIG. 4C, when the rewriting instruction unit 715 issues the rewriting instruction to rewrite the lowermost first layer image L1 to the rewritten layer image L1″, the layer image specifying unit 716 specifies the first cache image C1 including the developed layer image L1′ as the specific cache image, and specifies the developed layer images L2′ and L3′ constituting the specific cache image. Then, the development unit 712 develops the rewritten layer image L1″ and the layer images L2 and L3 corresponding to the developed layer images L2′ and L3′ specified by the layer image specifying unit 716. Next, the cache image generating unit 713 newly generates the third cache image C3 on the basis of the third cache image C3 and the second cache image C2, and newly generates the second cache image C2 on the basis of the developed layer images L2′ and L3′ corresponding to the second and third layer images L2 and L3 higher than the first layer image L1.

Finally, the cache image generating unit 713 newly generates the first cache image C1 only from the developed layer image obtained by developing the rewritten layer image L1″, and the generation process of the cache images C1 to C3 is ended. Further, the underlines shown in FIG. 4C show the layer images newly developed at the time of rewriting the first layer image L1. In general, when the layer images L1 to L9 are newly input, all of the layer images L1 to L9 must be developed. However, simply by developing “3” images of the layer images L1″, L2, and L3 using the second and third cache images C2 and C3, it is possible to perform the rewriting of the first layer image L1 with the rewritten layer image L1″, and thereby increasing efficiency.

In addition, it is possible to store the cache image C1, which is made of the developed layer image obtained by developing the rewritten layer image L1″ used for rewriting the lowermost first layer images L1, in the first cache 781 in a state independent from the developed layer images L2′ to L9′ corresponding to the other layer images L2 to L9. Therefore, when the rewritten layer image L1″ is rewritten again with a new rewritten layer image, it is possible to perform the rewriting of the cache image stored in the first cache 781 by the use of the first newly generated cache image C1 by developing only the newly input rewritten layer image into the raster format, and thereby greatly increasing efficiency.

(3) Rewriting of Layer Image L9 in GROUP III with Rewritten Layer Image

As shown in FIG. 4D, when the rewriting instruction unit 715 issues the rewriting instruction to rewrite the uppermost ninth layer image L9 to the rewritten layer image L9″, the layer image specifying unit 716 specifies the third cache image C3 including the developed layer image L9′ as the specific cache image, and specifies the developed layer images L7′ and L8′ constituting the specific cache image. Then, the development unit 712 develops the rewritten layer image L9″ and the layer images L7 and L8 corresponding to the developed layer images L7′ and L8′ specified by the layer image specifying unit 716. Next, the cache image generating unit 713 newly generates the first cache image C1 on the basis of the first cache image C1 and the second cache image C2, and newly generates the second cache image C2 on the basis of the developed layer images L7′ and L8′ corresponding to the seventh and eighth layer images L7 and L8 lower than the ninth layer image L9.

Finally, the cache image generating unit 713 newly generates the third cache image C3 only from the developed layer image obtained by developing the rewritten layer image L9″, and the generation process of the cache images C1 to C3 is ended. Further, the underlines shown in FIG. 4D show the layer images newly developed at the time of rewriting the ninth layer image L9. In general, when the layer images L1 to L9 are newly input, all of the layer images L1 to L9 must be developed. However, simply by developing “3” images of the layer images L7, L8, and L9″ using the first and second cache images C1 and C2, it is possible to perform the rewriting of the ninth layer image L9 with the rewritten layer image L9″, and thereby increasing efficiency.

In addition, it is possible to store the cache image C3, which is made of the developed layer image obtained by developing the rewritten layer image L9″ used for rewriting the uppermost ninth layer images L9, in the third cache 783 in a state independent from the developed layer images L1′ to L8′ corresponding to the other layer images L1 to L8. Therefore, when the rewritten layer image L9″ is rewritten again with a new rewritten layer image, it is possible to perform the rewriting of the cache image stored in the third cache 783 by the use of the third newly generated cache image C3 by developing only the newly input rewritten layer image into the raster format, and thereby greatly increasing efficiency.

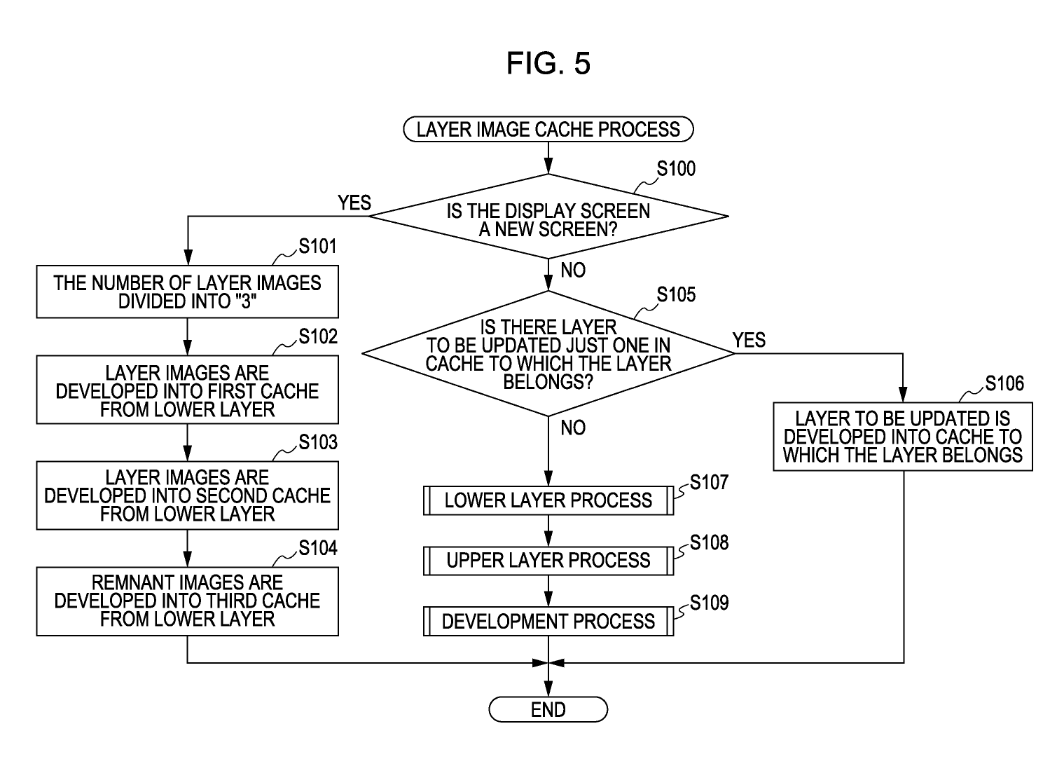

The developing processes described above require a high processing capability of the CPU 71. In this embodiment, since the number of the developing processes for developing the image (image data) into the raster format can be reduced, the load on the CPU 71 can be decreased. Therefore, even in an apparatus employing a low cost CPU 71 with comparatively low processing capability, it is possible to perform the rewriting of the layer images L1 to L9 constituting the synthetic image at high speed. Further, it is possible to perform an update process on the image displayed on the display unit 22 in accordance with the rewriting of the layer image without damage to the real time processing. Next, with reference to FIGS. 5 to 8, an example of a process when a part of layer image is rewritten will be described also with reference to FIG. 4. The processes described in the following are executed by various functions which are realized by causing the CPU 71 to execute the programs stored in the ROM 73.

Layer Image Cache Process

FIG. 5 is a view illustrating an example of the layer image cache process. First, in step S100, the cache image generating unit 713 determines whether or not the first to ninth layer images L1 to L9 input by the layer image input unit 711 are newly input. When it is determined as “YES”, the first to ninth layer images L1 to L9 are divided into “3” groups including a first layer image generating group made of the first to third layer images L1 to L3, a second layer image generating group made of the fourth to sixth layer images L4 to L6, and a third layer image generating group made of the seventh to ninth layer images L7 to L9 (step S101). Next, the first to third layer images L1 to L3 constituting the first layer image generating group are developed into the first cache 781 (step S102), the fourth to sixth layer images L4 to L6 constituting the second layer image generating group are developed into the second cache 782 (step S103), and the seventh to ninth layer images L7 to L9 constituting the third layer image generating group are developed into the third cache 783, and the process is ended (step S104).

In addition, when it is determined as “NO” in step S100, the layer image specifying unit 716 specifies one cache image among the first to third cache images C1 to C3, in which the layer image to be updated by the input rewritten layer image is included. The cache image generating unit 713 determines whether or not the specific cache image is configured of only the developed layer image of the layer image to be updated on the basis of the specification result by the layer image specifying unit 716 (step S105). When it is determined as “YES” in step S105, the cache image specified in step S105 is updated with the cache image generated by the cache image generating unit 713 on the basis of the developed layer images of the rewritten layer image, and thus the process is ended (step S106). On the other hand, when it is determined as “NO” in step S105, the “Lower Layer Process”, “Upper Layer Process”, and “Development Process” described below are performed, and thus the process is ended (steps S107 to S109).

Lower Layer Process

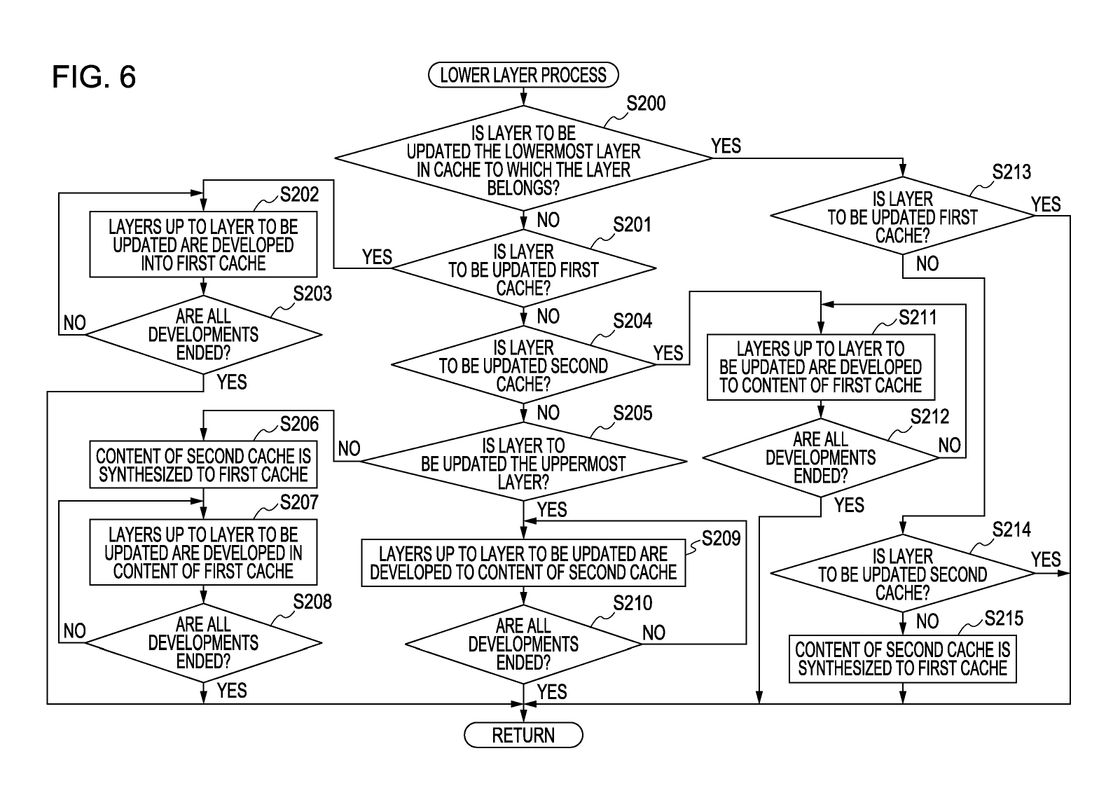

FIG. 6 is a view illustrating an example of the lower layer process. First, in step S200, the cache image generating unit 713 determines whether or not the layer image to be updated is the lowermost layer image of the cache image including the layer image to be updated. When it is determined as “NO” in step S200, it is determined whether or not the cache image including the layer image to be updated is stored in the first cache 781 (step S201). When it is determined as “YES” in step S201, the layer image lower than the layer image to be updated is developed into the first cache 781, and the process is ended (steps S202 and S203).

In addition, when it is determined as “NO” in step S201, it is determined whether or not the cache image including the layer image to be updated is stored in the second cache 782 (step S204). When it is determined as “NO” in step S204, it is determined whether or not the layer image to be updated is the uppermost ninth layer image L9 (step S205). When it is determined as “NO”, the content of the second cache 782 is synthesized into the first cache 781 (step S206). In addition, the remnant images among the layer images lower than the layer image to be updated are developed into the first cache 781, and the process is ended (steps S207 and S208).

On the other hand, when it is determined as “YES” in step S205, the remnant images among the layer images lower than the layer image to be updated are developed into the content of the second cache 782, and the process is ended (steps S209 and S210). In addition, when it is determined as “YES” in step S204, the remnant images among the layer images lower than the layer image to be updated are developed into the content of the first cache 781, and the process is ended (steps S211 and S212).

In addition, when it is determined as “YES” in step S200, it is determined whether or not the cache image including the layer image to be updated is stored in the first cache 781 (step S213). When it is determined as “YES” in step S213, the process is ended as it is. When it is determined as “NO”, it is determined whether or not the cache image including the layer image to be updated is stored in the second cache 782 (step S214). When it is determined as “YES” in step S214, the process is ended as it is. When it is determined as “NO”, the content of the second cache 782 is synthesized to the first cache 781, and the process is ended (step S215).

Upper Layer Process

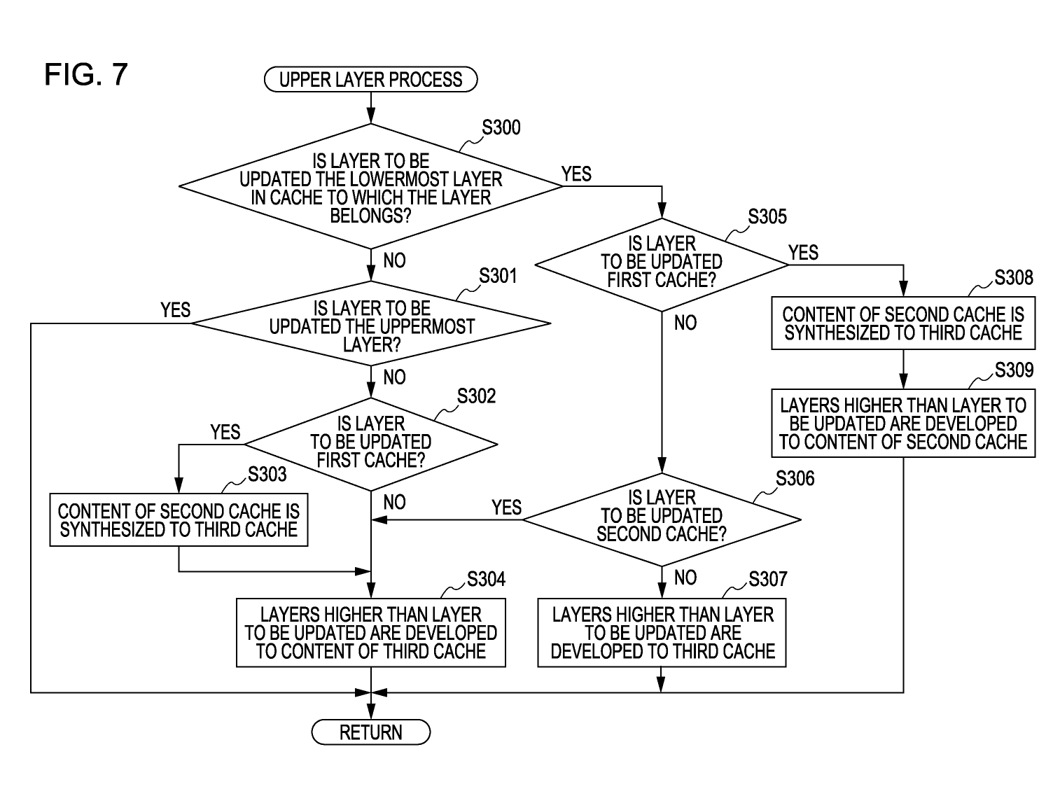

FIG. 7 is a view illustrating an example of the upper layer process. First, in step S300, the cache image generating unit 713 determines whether or not the layer image to be updated is the lowermost layer image of the cache image including the layer image to be updated. When it is determined as “NO” in step S300, the cache image generating unit 713 determines whether or not the layer image to be updated is the uppermost ninth layer image L9 (step S301). When it is determined as “YES”, the process is ended. On the other hand, when it is determined as “NO” in step S301, it is determined whether or not the cache image including the layer image to be updated is stored in the first cache 781 (step S302). In step S302, when it is determined as “YES”, the content of the second cache 782 is synthesized to the third cache 783 (step S303). Further, the remnant images among the layer images higher than the layer image to be updated are developed into the third cache 783, and the process is ended (step S304).

In addition, when it is determined as “YES” in step S300, it is determined whether or not the cache image including the layer image to be updated is stored in the first cache 781 (step S305). When it is determined as “NO” in step S305, it is determined whether or not the cache image including the layer image to be updated is stored in the second cache 782 (step S306). When it is determined as “YES”, the process proceeds to step S304. On the other hand, when it is determined as “NO” in step S306, the remnant images among the layer images higher than the layer image to be updated are developed into the third cache 783 (step S307). In addition, when it is determined as “YES” in step S305, the content of the second cache 782 is synthesized to the third cache 783 (step S308). Further, the remnant images among the layer images higher than the layer image to be updated are developed into the second cache 782, and the process is ended (step S309).

Development Process

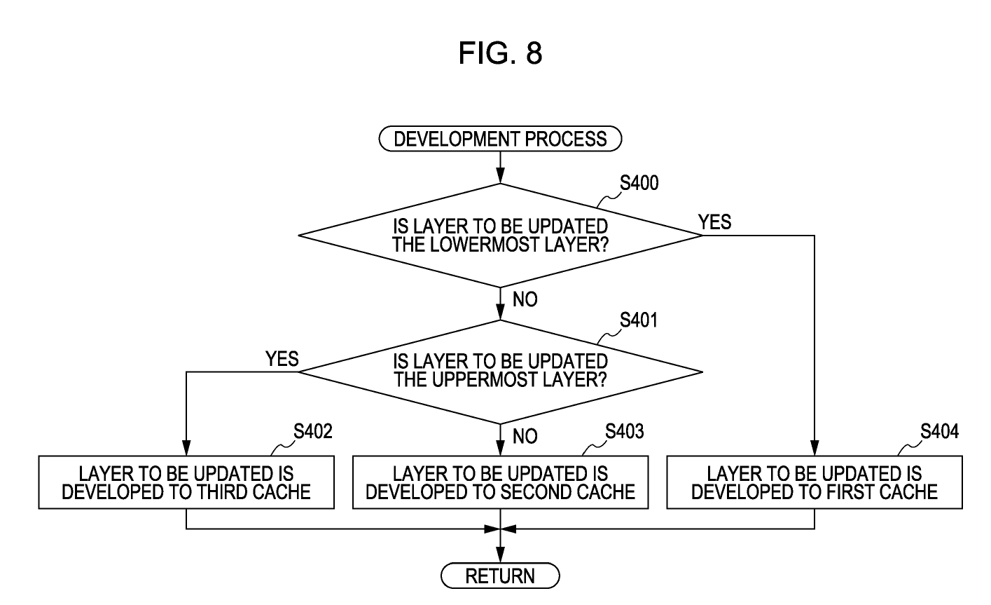

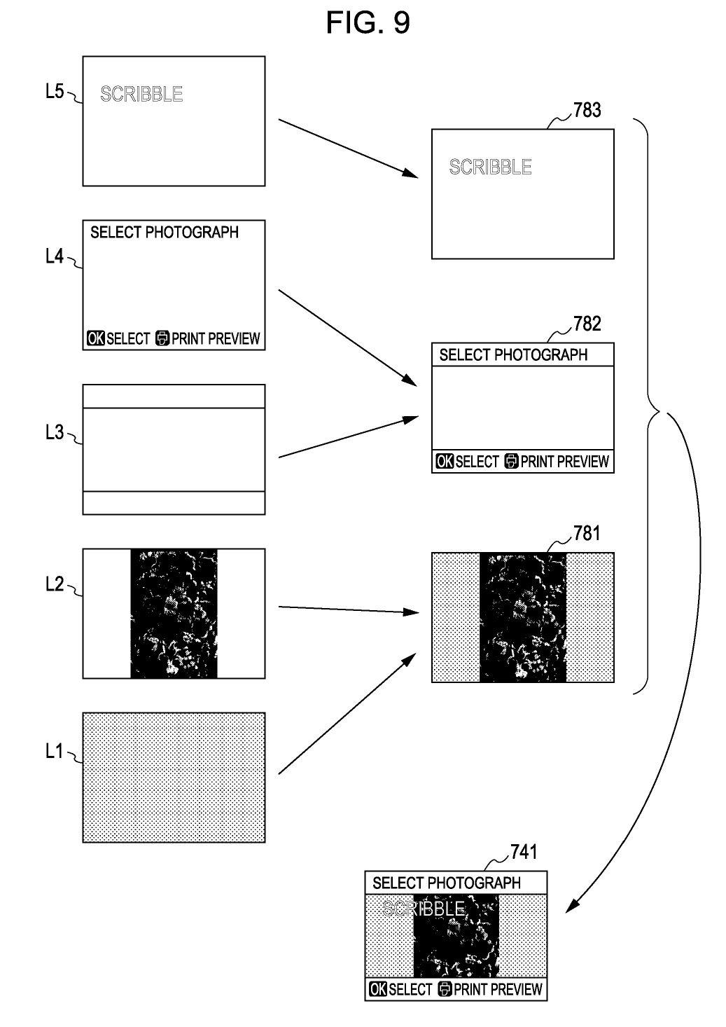

FIG. 8 is a view illustrating an example of the development process. First, in step S400, the cache image generating unit 713 determines whether or not the layer image to be updated is the lowermost first layer image L1. when it is determined as “NO” in step S400, the cache image generating unit 713 determines whether or not the layer image to be updated is the uppermost ninth layer image L9 (step S401). When it is determined as “YES”, the uppermost rewritten layer image to be updated is developed into the third cache 783, and the process is ended (step S402). On the other hand, when it is determined as “NO” in step S401, the rewritten layer image to be updated is developed into the second cache 782, and the process is ended (step S403). In addition, when it is determined as “YES” in step S400, the lowermost rewritten layer image to be updated is developed into the first cache 781, and the process is ended (step S404). Next, with reference to FIGS. 9 to 13, a specific example when some layer images are rewritten will be described also with reference to FIG. 4.

FIG. 9 is a view illustrating an example of a process when the first to fifth layer images L1 to L5 are newly input. In the example described below, the background image of the photograph is input as the first layer image L1 from the lower layer, the photograph image is input as the second layer image L2, the background image of the characters is input as the third layer image L3, the character and icon images are input as the fourth layer image L4, and the scribble image drawn by the touch pen 23 is input as the fifth layer image L5. As shown in FIG. 9, when the first to fifth layer images L1 to L5 are newly input by the layer image input unit 711, all of the layer images L1 to L5 are developed into the raster format by the development unit 712.

Then, the first cache image C1 is generated by the cache image generating unit 713 on the basis of the first and second layer images L1 and L2 and is stored in the first cache 781, the second cache image C2 is generated by the cache image generating unit 713 on the basis of the third and fourth layer images L3 and L4 and is stored in the second cache 782, and the third cache image C3 is generated by the cache image generating unit 713 on the basis of the fifth layer image L5 and is stored in the third cache 783. Finally, the first to third cache images C1 to C3 separately stored in the cache memory 78 are synthesized by the use of the synthesizing unit 714 and the synthetic image is stored in the VRAM 741, and the image is thereby displayed on the display unit 22.

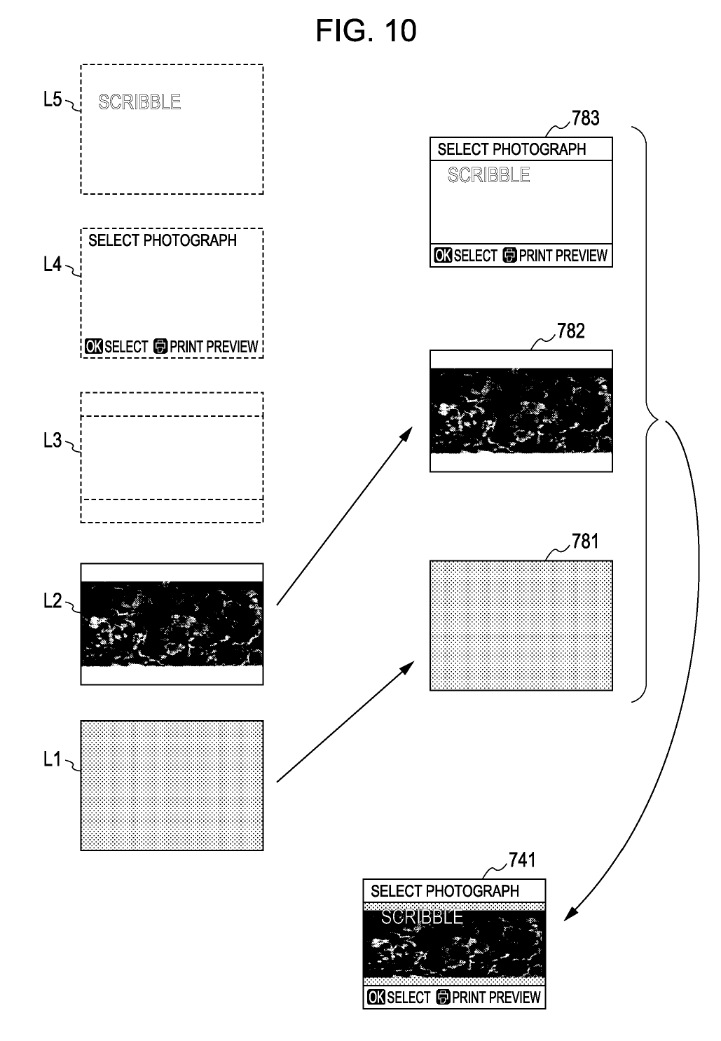

FIG. 10 is a view illustrating an example of a process when the second layer image L2 is rewritten from the state shown in FIG. 9. As shown in FIG. 10, when the rewritten layer image of the photograph image of the second layer image L2 is newly input, only the first layer image L1 specified by the layer image specifying unit 716 and the newly input second layer image L2 (rewritten layer image) are developed by the development unit 712. In addition, the content of the second cache 782 shown in FIG. 9 is synthesized to the content of the third cache 783 by the cache image generating unit 713, so that the third cache image C3 is newly generated. Then, the first cache image C1 is generated by the cache image generating unit 713 on the basis of the newly developed first layer image L1 and is stored in the first cache 781. The second cache image C2 is generated by the cache image generating unit 713 on the basis of the newly developed second layer image L2 and is stored in the second cache 782. Finally, the first to third cache images C1 to C3 separately stored in the cache memory 78 are synthesized by the use of the synthesizing unit 714 and the synthetic image is stored in the VRAM 741, and the rewritten image of the second layer image L2 is thereby displayed on the display unit 22.

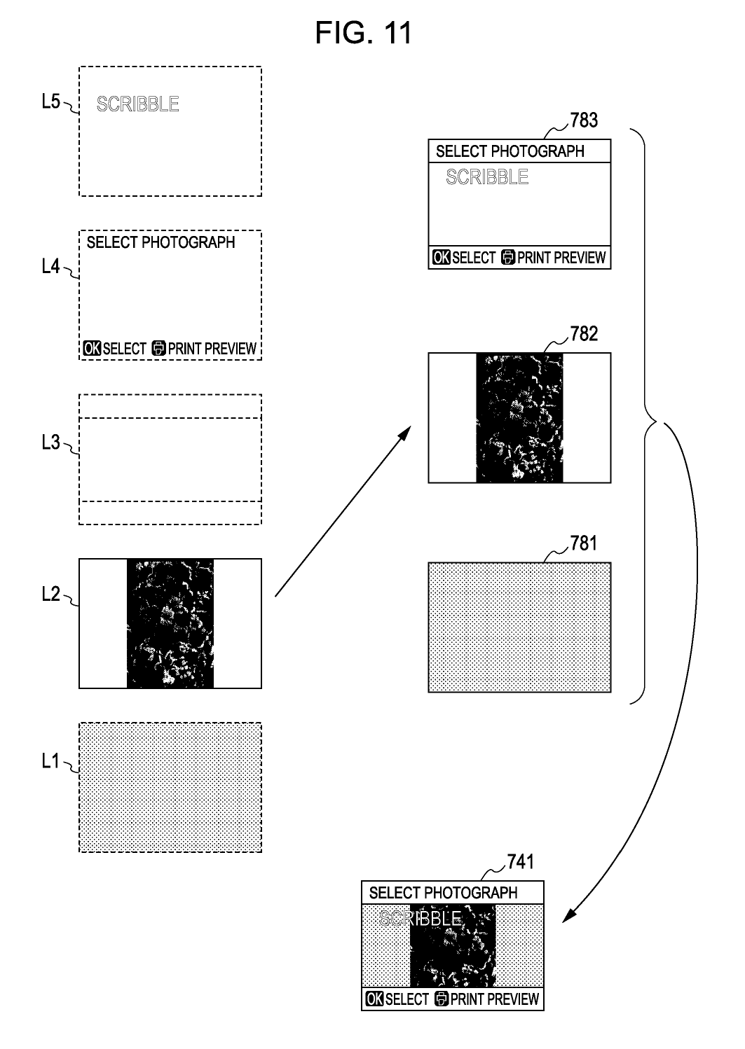

FIG. 11 is a view illustrating an example of a process when the second layer image is rewritten again from the state shown in FIG. 10. As shown in FIG. 11, when the rewritten layer image of the photograph image of the second layer image L2 is newly input, only the second layer image (rewritten layer image) specified by the layer image specifying unit 716 is developed by the development unit 712. In addition, the second cache image C2 is generated by the cache image generating unit 713 on the basis of the newly developed second layer image L2 and is stored in the second cache 782. Finally, the first to third cache images C1 to C3 separately stored in the cache memory 78 are synthesized by the use of the synthesizing unit 714 and the synthetic image is stored in the VRAM 741, and the rewritten image of the second layer image L2 is thereby displayed on the display unit 22.

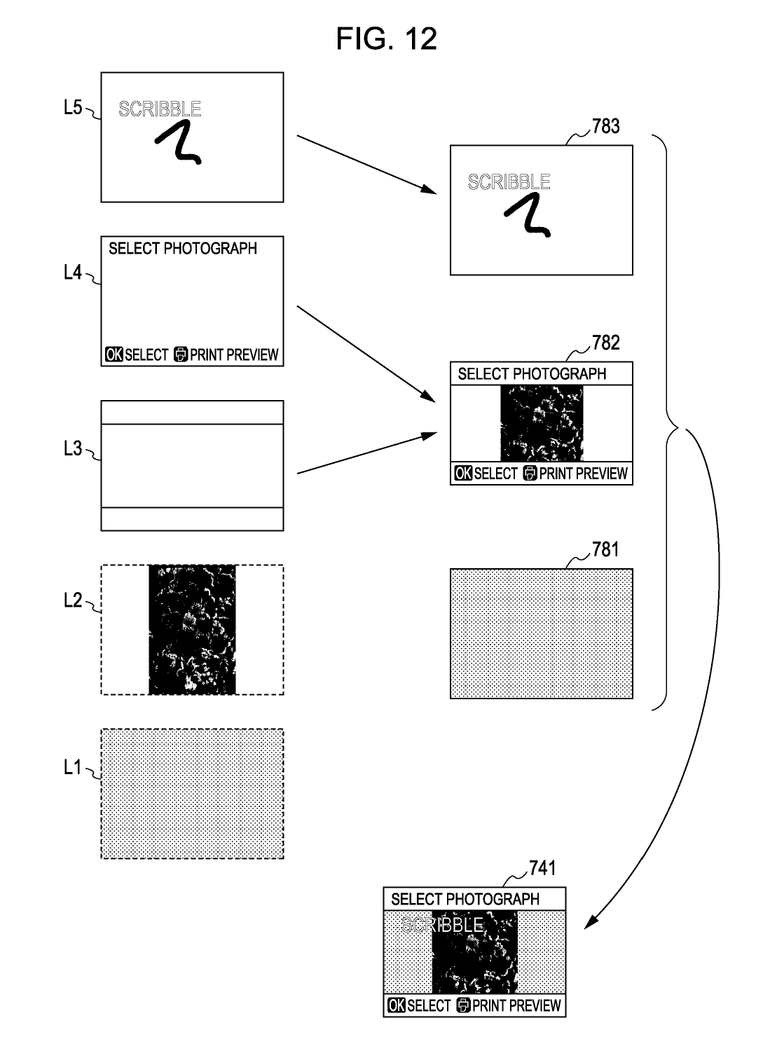

FIG. 12 is a view illustrating an example of a process when the scribble image is input by the touch pen 23 and the fifth layer image is rewritten. As shown in FIG. 12, when the rewritten layer image of the scribble image of the fifth layer image L5 is newly input, only the third and fourth layer images L3 and L4 specified by the layer image specifying unit 716 and the newly input fifth layer image L5 (rewritten layer image) are developed by the development unit 712. In addition, the second cache image C2 is newly generated by the cache image generating unit 713 on the basis of the newly developed third and fourth layer images L3 and L4 and the content of the second cache 782, and the second cache image C2 is stored in the second cache 782. Then, the third cache image C3 is generated by the cache image generating unit 713 on the basis of the newly developed fifth layer image L5 and is stored in the third cache 783. Finally, the first to third cache images C1 to C3 separately stored in the cache memory 78 are synthesized by the synthesizing unit 714 and the synthetic image is stored in the VRAM 741, and the rewritten image of the fifth layer image L5 is thereby displayed on the display unit 22.

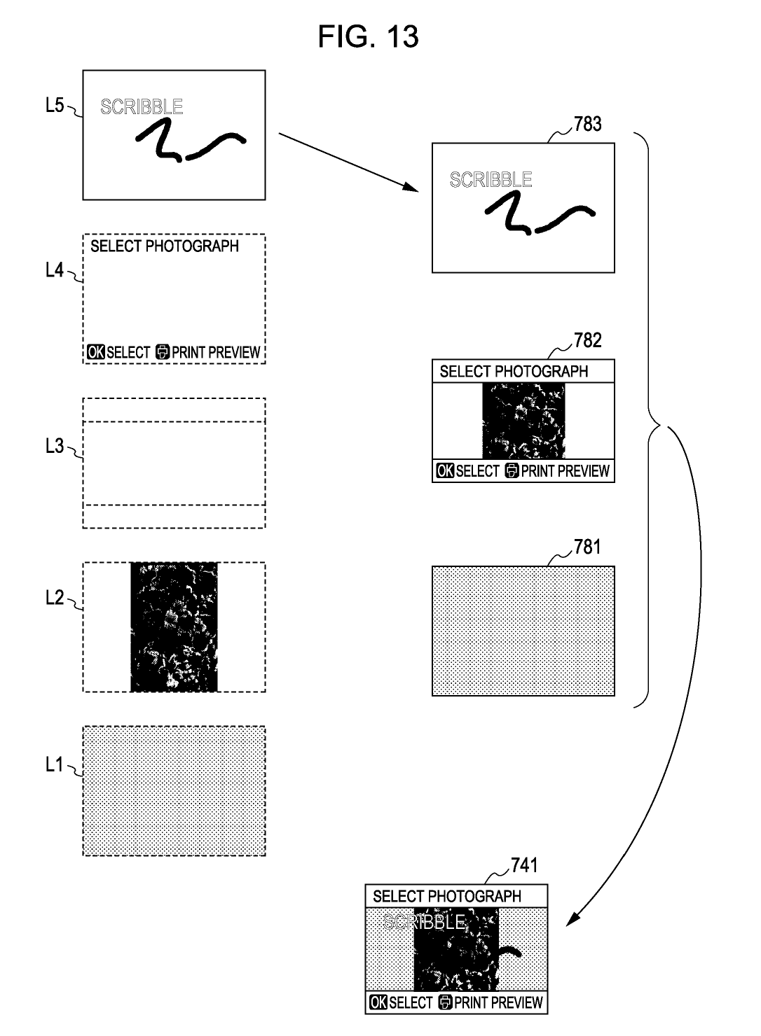

FIG. 13 is a view illustrating an example of a process when the fifth layer image is rewritten again from the state shown in FIG. 12. As shown in FIG. 13, when the rewritten layer image of the scribble image of the fifth layer image L5 is newly input, only the fifth layer image (rewritten layer image) specified by the layer image specifying unit 716 is developed by the development unit 712. In addition, the third cache image C3 is generated by the cache image generating unit 713 on the basis of the newly developed fifth layer image L5 by the cache image generating unit 713 and is stored in the third cache 783. Finally, the first to third cache images C1 to C3 separately stored in the cache memory 78 are synthesized by the use of the synthesizing unit 714 and the synthetic image is stored in the VRAM 741, and the rewritten image of the fifth layer image L5 is thereby displayed on the display unit 22.

As described above, in this embodiment, when the rewritten layer image is input by the layer image input unit 711 in order to rewrite one layer image among the layer images L1 to L9, the layer image storage unit 77 stores the rewritten layer image instead of the one layer image according to the rewriting instruction issued by the rewriting instruction unit 715. Then, according to the rewriting instruction, the development unit 712 develops the layer image specified by the layer image specifying unit 716 and the rewritten layer image among the rewritten layer images stored in the layer image storage unit 77 and the layer images except the one layer image in accordance with the rewriting instruction. The cache image generating unit 713 newly generates the cache image on the basis of the layer image developed according to the rewriting instruction and all of the cache images except the specific cache image among the cache images C1 to C3 stored in the cache memory 78. Therefore, even though not all of the layer images including the rewritten layer image stored in the layer image storage unit 77 are developed into the raster format, it is possible to newly generate the cache images C1 to C3 by developing only the rewritten layer image for the rewriting and some layer images among the layer images L1 to L9 stored in the layer image storage unit 77. Further, the newly generated cache images C1 to C3 are synthesized by the synthesizing unit 714 and thereby it is possible to generate the synthetic image with more efficiency.

It is highly probable that one layer image subjected to the rewriting with the rewritten layer image will be rewritten again with a new rewritten layer image. According to the above-mentioned configuration, since the cache image generating unit 713 generates one cache image made of only the developed layer image corresponding to the rewritten layer image according to the rewriting instruction issued by the rewriting instruction unit 715, when the rewritten layer image is rewritten again, it is possible to rewrite the synthetic image displayed on the display unit 22 simply by developing the newly input rewritten layer image into the raster format. Therefore, efficiency is very good.

The invention is not limited to the embodiments described above, but various changes other than the above-mentioned explanation can be made herein without departing from the main points of the invention. For example, in the embodiments described above, the above-mentioned various functions are configured to be realized by causing the CPU 71 to execute the various programs stored in the ROM 73. However, these functions may be realized by hardware. In addition, in the embodiments described above, the layer image storage unit 77 and the cache memory 78 are provided separately to the RAM 72, but these units may be configured by the use of the RAM 72.

In addition, the memory capacity of the layer image storage unit 77 and the memory capacity of the cache memory 78 are not limited to the example described above. The capacity of the cache memory 78 can be arbitrarily configured as long as two or more layer images can be stored therein. Further, the capacity of the cache memory 78 is not necessarily a capacity capable of storing all of the input layer images. The effects described above can be obtained as long as the capacity of the cache memory 78 is a capacity capable of separately storing the cache images which are generated by arbitrarily combining the input layer images. In particular, if the capacity of the cache memory 78 is a capacity capable of storing three cache images, the plural layer images can be divided into groups of the upper layer group, the intermediate layer group, and the lower layer group, so that the generation of the cache images can be performed. Accordingly, efficiency is greatly enhanced.

In addition, in the above-mentioned embodiments, the photo printer 10 of the ink cartridge type has been described as an example, but the invention may be applied to other image display apparatuses such as a printer of an ink jet type. Further, the invention can be widely applied to apparatuses capable of displaying images such as photo viewers, digital still cameras, projectors, portable telephones capable of displaying photos, handheld game machines, and personal computers. In particular, when the invention is applied to an apparatus with a micro processor having low processing capability mounted thereon, the above-mentioned effects can be remarkable.

What is claimed is:

1. An image display apparatus which includes an image memory for storing a synthetic image obtained by synthesizing a plurality of layer images and displays the synthetic image stored in the image memory on a display unit, the apparatus comprising:
a layer image input unit for inputting the layer images;
a layer image storage unit for storing the layer images input by the layer image input unit;
a development unit for developing the layer images stored in the layer image storage unit into developed layer images of a raster format;
a cache image generating unit for forming a plurality of cache image generating groups by dividing the developed layer images into a plurality of groups, generating a cache image of the cache image generating group by synthesizing the developed layer images of the layer images provided that the cache image generating group includes a plurality of the layer images, and generating a cache image of the cache image generating group made of the developed layer image of one layer image provided that the cache image generating group includes the one layer image;
an image cache unit for separately storing the cache image corresponding to every cache image generating group generated by the cache image generating unit;
a synthesizing unit for synthesizing the cache images stored in the image cache unit into the synthetic image;
a rewriting instruction unit for instructing the layer image storage unit to rewrite one layer image to a rewritten layer image according to the input of the rewritten layer image for rewriting the one layer image among the layer images by the layer image input unit; and
a layer image specifying unit, which operates according to a rewriting instruction issued by the rewriting instruction unit, for specifying the cache image including the developed layer image corresponding to the one layer image among the cache images as a specific cache image, and for specifying the layer images corresponding to all of the developed layer images constituting the specific cache image,
wherein according to the rewriting instruction,
the layer image storage unit stores the rewritten layer image instead of the one layer image,
the development unit develops the layer image specified by the layer image specifying unit and the rewritten layer image among the rewritten layer images stored in the layer image storage unit and the layer images except the one layer image, and
the cache image generating unit newly generates the cache image on the basis of the developed layer images developed according to the rewriting instruction and all of the cache images except the specified cache image among the cache images stored in the image cache unit.

2. The image display apparatus according to claim 1, wherein the image cache unit stores at least three cache images, and
wherein according to the rewriting instruction, the cache image generating unit generates:
at least one cache image made of one of the developed layer images corresponding to the layer images except the rewritten layer image; and
the one cache image made of only the developed layer image corresponding to the rewritten layer image.

3. The image display apparatus according to claim 2, wherein the image cache unit includes first to third caches to store the three cache images,
wherein the layer image input unit inputs “N” layer images from a lower first layer image to an upper Nth layer image,
wherein the cache image generating unit divides the developed “N” layer images obtained by developing the first to Nth layer images into three groups of first to third cache image generating groups from a lower layer, and generates the first to third cache images corresponding to the first to third cache image generating groups, respectively, and
wherein the image cache unit stores the first to third cache images in the first to third caches from a lower layer in this order,
wherein according to the rewriting instruction, when the rewritten layer image is an image to rewrite the uppermost Nth layer image, the cache image generating unit newly generates first and second cache images on the basis of the first cache image, the second cache image, and all of the developed layer images corresponding to the layer images lower than the Nth layer image among the developed layer images constituting the third cache image, and newly generates the third cache image on the sole basis of the developed layer image obtained by developing the rewritten layer image.

4. The image display apparatus according to claim 3, wherein according to the rewriting instruction, when the rewritten layer image is an image to rewrite the lowermost first layer image, the cache image generating unit newly generates third and second cache images on the basis of the third cache image, the second cache image, and all of the developed layer images corresponding to the layer images higher than the first layer image among the developed layer images constituting the first cache image, and newly generates the first cache image on the sole basis of the developed layer image obtained by developing the rewritten layer image.

5. The image display apparatus according to claim 3, wherein according to the rewriting instruction, when the rewritten layer image is an image to rewrite the nth (n: 2≦n≦N−1) layer image, the cache image generating unit newly generates the first cache image on the basis of the developed layer image corresponding to the layer images lower than the nth layer image, newly generates the third cache image on the basis of the developed layer image corresponding to the layer images higher than the nth layer image, and newly generates the second cache image on the sole basis of the developed layer image obtained by developing the rewritten layer image.

6. A program for controlling an image display apparatus which includes an image memory for storing a synthetic image obtained by synthesizing a plurality of layer images and displays the synthetic image stored in the image memory on a display unit, the program causing the image display apparatus to execute:
a function of inputting the layer images by using a layer image input unit;
a function of storing the layer images input by the layer image input unit in a layer image storage unit;
a developing function of developing the layer images stored in the layer image storage unit into developed layer images of a raster format;
a cache image generating function of forming a plurality of cache image generating groups by dividing the developed layer images into a plurality of groups, generating a cache image of the cache image generating group by synthesizing the developed layer images of the layer images provided that the cache image generating group includes a plurality of the layer images, and generating a cache image of the cache image generating group made of the developed layer image of one layer image provided that the cache image generating group includes the one layer image;
a function of separately storing the cache image corresponding to every cache image generating group generated by the cache image generating unit in an image cache unit;
a synthesizing function of synthesizing the cache image stored in the image cache unit into the synthetic image;
a rewriting instruction function of instructing the layer image storage unit to rewrite one layer image to a rewritten layer image according to the input of the rewritten layer image for rewriting the one layer image among the layer images by the layer image input unit; and
a layer image specifying function, according to a rewriting instruction issued by the rewriting instruction unit, of specifying the cache image including the developed layer image corresponding to the one layer image among the cache images as a specific cache image, and of specifying the layer images corresponding to all of the developed layer images constituting the specific cache image,
wherein according to the rewriting instruction,
the rewritten layer image is stored in the layer image storage unit instead of the one layer image,
the development function develops the layer image specified by the layer image specifying function and the rewritten layer image among the rewritten layer image stored in the layer image storage unit and the layer images except the one layer image, and
the cache image generating function newly generates the cache image on the basis of the developed layer images developed according to the rewriting instruction and all of the cache images except the specified cache image among the cache images stored in the image cache unit.
